(19) United States
(12) Patent Application Publication
(10) Pub. No.: US 2017/0043377 A1
(43) Pub. Date: Feb. 16, 2017

(54) WATER EXCHANGE DEVICE FOR A BIRDBATH

(71) Applicant: John Barton Huber, Cincinnati, OH (US)

(72) Inventor: John Barton Huber, Cincinnati, OH (US)

(21) Appl. No.: 14/822,049

(22) Filed: Aug. 10, 2015

(51) Int. Cl. B08B 3/02; B08B 17/02; A01K 45/00

(52) U.S. Cl. CPC B08B 3/02; A01K 45/002; B08B 17/02

(57) ABSTRACT

A water exchange device for a birdbath comprises a stanchion and a head. A first passageway extends entirely through the length of the stanchion body from an upper end to a lower end. Also, at least one stanchion duct extends from the first passageway exiting the stanchion body at a stanchion duct aperture. The head is fixedly secured to the stanchion body so as to be positioned spaced from, and not covering the stanchion duct aperture(s). A second passageway extends from a base of the head into the head body forming a through connection with the first passageway. The head also includes at least one head duct extending from the second passageway in an angled direction toward the base of the head body, exiting the head body at a head duct aperture.

### BACKGROUND

Various aspects of the present disclosure relate generally to birdbaths and more specifically to the automated maintenance of a birdbath, such as to clean a basin of the birdbath and/or to restore clean water to the basin of the birdbath.

Many birdbaths include a shallow basin that is usually perched on a pedestal. The inside of the basin defines a hollow space that can be filled with water, either by a natural means such as rain or by artificial means such as a person filling the basin using water from a conventional garden hose. When the birdbath basin is full of water, birds can enjoy the birdbath for bathing or as a source of drinking water.

However, the water in a birdbath will become contaminated over time. For instance, water in a birdbath basin may become dirty over time due to birds washing themselves in the water or through bird excrement left in the water. Also, over time, scum, algae, and, other build-up may contaminate the water. Still further, the birdbath basin may become dirty due to leaves, twigs, pinecones, dirt and, other debris that have fallen into the birdbath basin.

### BRIEF SUMMARY

According to aspects of the present disclosure, a water exchange device for a birdbath comprises a stanchion and a head. The stanchion includes a stanchion body having an upper end, a length, and a lower end opposite the upper end. Moreover, a first passageway extends entirely through the length of the stanchion body from the upper end to the lower end. Also, at least one stanchion duct extends from the first passageway outward relative to the length of the stanchion body, exiting the stanchion body at a stanchion duct aperture. The head is fixedly positioned to the stanchion body so as to be positioned spaced from, and not covering the stanchion duct aperture(s). The head includes a head body having a cap, a length, and a base opposite the cap. A second passageway extends from the base into the head body forming a through connection with the first passageway. The head also includes at least one head duct extending from the second passageway outward relative to the length of the head body, and in an angled direction toward the base relative to the length of the head body, exiting the head body at a head duct aperture.

### BRIEF DESCRIPTION OF THE SEVERAL VIEWS OF THE DRAWINGS

FIG. 1 is a view of a water exchange device for a birdbath with the head pulled away from the stanchion to illustrate parts of the device according to various aspects of the present disclosure;

FIG. 2 is a cross-section view of the water exchange device of FIG. 1 taken along line A-A, according to aspects of the present disclosure;

FIG. 3 is a zoomed-in view of a head and a section of the stanchion body according to aspects of the present disclosure;

FIG. 4 is a schematic view illustrating a bushing that can be used to secure the head to the stanchion according to aspects of the present disclosure;

FIG. 5 is a top view illustrating direction of water discharge from the head according to aspects of the present disclosure;

FIG. 6 is a top view illustrating direction of water discharge from the stanchion body according to aspects of the present disclosure;

FIG. 7 is a partial view illustrating the water exchange device mounted to the basin of a birdbath according to aspects of the present disclosure;

FIG. 8 is a schematic top view illustrating a water direction during a water cleaning operation;

FIG. 9 is a schematic cross-section view of a first phase of a water cleaning operation, according to aspects of the present disclosure;

FIG. 10 is a schematic cross-section view of a second phase of a water cleaning operation, according to aspects of the present disclosure;

FIG. 11A is a schematic view of a timer system for controlling a cleaning and replenishing operation, according to aspects of the present disclosure;

FIG. 11B is a schematic illustration of a flow control device useful with the timer system of FIG. 11A, according to aspects of the present disclosure;

FIG. 12 is a schematic view of a birdbath connected to an underground hose, according to aspects of the present disclosure; and

FIG. 13 is a view of an example clamp to secure the basin to the pedestal, and to further stabilize the entire birdbath by holding underground the hose which is connected to the birdbath, according to aspects of the present disclosure.

### DETAILED DESCRIPTION

Many birdbaths are in various stages of disuse or unsightliness, and too often serve as a breeding ground for mosquitoes and algae. However, according to various aspects of the present disclosure, a water exchange device for the automated maintenance of a birdbath is provided. The water exchange device maintains a clean basin surface with timely exchanges of water, by depriving basin-staining agents of the sustained time-in-place, they would otherwise need to gain a foothold on the basin surface. The water exchange device includes a stanchion having a hollow through the length thereof, and a fixed head mounted at an end portion of the stanchion. A plurality of stanchion ducts are positioned around the circumference of the stanchion below the head. Moreover, the head includes a head cavity that communicably couples to the hollow in the stanchion, and a plurality of head ducts that pass between the head cavity and the outside surface of the head. Water passes through the hollow and into the head cavity. Moreover, water is expelled through the head ducts and stanchion ducts.

In use, the water exchange device is installed in the basin of a birdbath, and is connected to a water source, a timer and flow control to automatically exchange stale basin water with fresh water on a scheduled cycle. More particularly, the water exchange device maintains a clean birdbath basin and clean water within the basin using an exchange cycle, which includes: an emptying cycle that utilizes water at a certain pressure sufficient to expel or otherwise empty standing water from the basin of the birdbath, and a refill cycle with water at a lower pressure than the emptying cycle that allows the basin to refill with fresh water. In certain implementations, the water from the water exchange device may not scrub the basin to remove stains. Instead, the water exchange device (and associated kit) performs the exchange cycle (e.g., which may take between 2-3 minutes) at predetermined intervals, e.g., six hour intervals, three times per day during the hours of peak bird activity. This schedule of exchanges does not permit stain-causing agents sufficient time to secure an attachment to the basin surface, and thus does not allow stains to form in the first place. In this regard, the water exchange device herein efficiently automates the tasks of jettisoning stale basin water and debris, refilling the basin with fresh water, and preventing basin stains. Accordingly, a self-cleaning birdbath is realized.

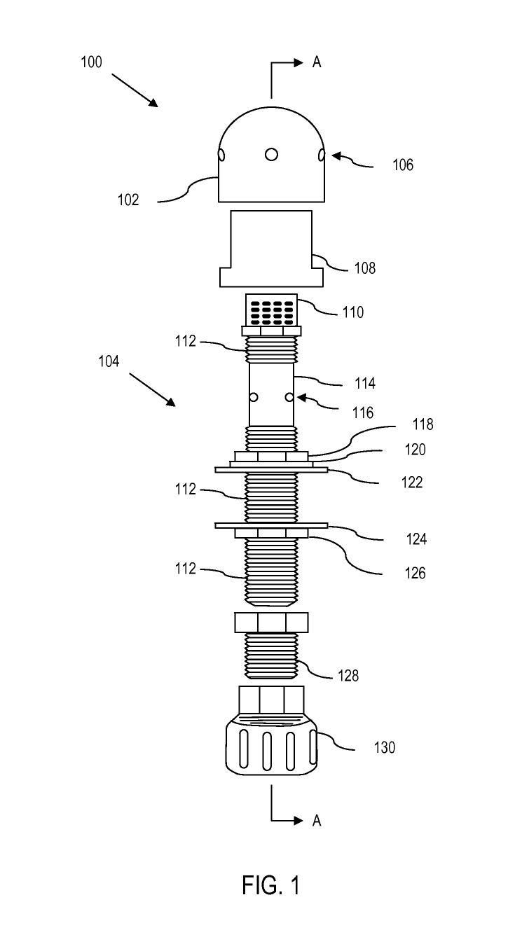

Turning now to the drawings and in particular to FIG. 1, a water exchange device 100 is illustrated. The water exchange device includes in general, a head 102 that is fixedly connected to a stanchion 104. As illustrated, the head 102 includes at least one (typically a plurality) head duct aperture 106 around the circumference thereof. The head duct apertures 106 are discussed in greater detail herein. Moreover, the head 102 is fixedly coupled to the stanchion 104, e.g., via an optional bushing 108 and a corresponding reducing bushing 110. However, the use of bushings is by way of illustration, and other methods may be utilized to couple the head 102 to the stanchion 104.

The stanchion 104 is illustrated as a tube-shaped member. In the illustrative implementation, a substantial length of the stanchion 104 includes male threads 112. The use of male threads 112 makes the water exchange device 100 relatively versatile and easily installed in a number of different birdbaths. For instance, the continuous-running threads allow the working height of the discharges to be readily adjusted during set-up. This feature enables the water exchange device 100 to be adapted to many birdbath basin designs. Moreover, the male threads 112 facilitate fixed attachment of the head 102 to the stanchion 104 via the optional bushing (or bushings) e.g., bushing 108 and reducing bushing 110. Where the water exchange device 100 is custom made for a particular application, the threaded portion can be reduced.

As will be described in greater detail herein, the stanchion 104 includes a discharge area 114 that includes at least one stanchion duct aperture 116 around the circumference of the body of the stanchion 104. However, in practice there is typically a plurality of stanchion duct apertures 116. As illustrated, the discharge area 114 of the stanchion body is free of male threads around the circumference of the stanchion body where the stanchion duct aperture(s) 116 exit(s) the stanchion body.

To secure the water exchange device 100 to a birdbath (not shown), the water exchange device 100 can include any necessary structures. For instance, as illustrated, the water exchange device 100 includes a top jam nut 118, a flat washer 120, and a first neoprene flat washer 122 that tighten down to the top of a birdbath basin, and a flat metal washer 124 and bottom jam nut 126 that tighten against a bottom of the birdbath basin. Notably, the head 102 threadably attaches to the stanchion 104 above the discharge area 114 of the stanchion body, whereas the top jam nut 118 and other hardware necessary to secure the water exchange device 100 to the birdbath basin threadably attaches to the stanchion 104 below the discharge area 114.

The water exchange device 100 can also include any necessary couplers and attachments, such as an optional reducing bushing 128, swivel adapter 130, etc.

In illustrative examples, the head 102 comprises a Polyvinyl Chloride (PVC) head, e.g., 0.5 inches (1.27 centimeters) to 1.25 inches (3.175 centimeters) inside diameter female slip PVC cap. In an example embodiment where the head 102 comprises a 1.25 inches (3.175 centimeters) inside diameter female slip PVC cap, the bushing 108 can comprise a corresponding PVC 1.25 (3.175 centimeters)×0.5 inch (1.27 centimeters) female pipe thread.

Where a relatively large head 102 is desired, it may be necessary to use a reducer to attach to the stanchion 104. As such, a 0.5 inches (1.27 centimeters) slip×0.375 inch (0.953 centimeter) female pipe threaded reducing bushing 108 may be used.

Keeping with the above example, the stanchion 104 comprises a tapered 0.375 (0.95 centimeter) male pipe thread comprising a 0.375 (0.95 centimeter) inside diameter, lead-free, brass shank nipple that is approximately 4 inches (10.16 centimeters) in overall length.

The discharge area 114 may be an unthreaded portion that is positioned approximately 0.4 inches (1 centimeter) from an end of the stanchion 104. This leaves male threads 112 above the discharge area 114 to secure the head 102 to the stanchion 104 as set out above. The discharge area 114 supports the stanchion duct aperture(s) 116 and thus may extend down a length of approximately 0.3 inches (0.762 centimeters).

In an example implementation, the male threads 112 run continuously from the bottom of the discharge area 114 to the bottom of the stanchion 104.

The top jam nut 118 may comprise a lead-free, brass jam nut that threads onto the male threads 112. Likewise, the washer 120 may comprise a lead-free, brass flat washer. Similarly, the washer 124 may comprise a lead-free, brass flat washer, and the bottom jam nut 126 may comprise a lead-free, brass jam nut.

In an example implementation, the optional reducing bushing 128 comprises a 0.5 inches (1.27 centimeter) to 0.75 inches (1.9 centimeter) female pipe threaded reducing bushing. Accordingly, the swivel adapter 130 comprises a 0.5 inches (1.27 centimeter) to 0.75 inches (1.9 centimeter) female garden hose adapter.

In practice, dimensions can vary from the above-examples, e.g., depending upon the desired size of the water exchange device 100, the size of the birdbath, etc.

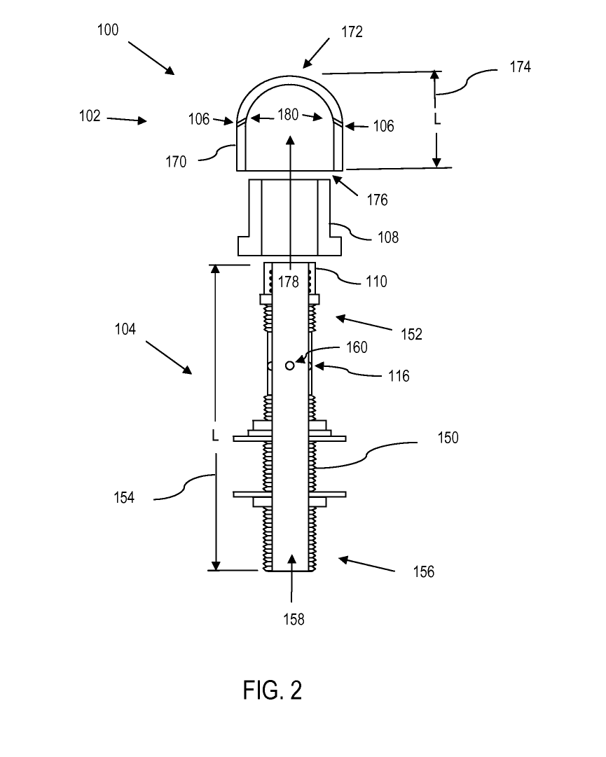

Referring to FIG. 2, the water exchange device 100 of FIG. 1 is seen taken along cross-section A-A. The optional bushing 128 and swivel adapter 130 have been removed for clarity of discussion.

The stanchion 104 includes a stanchion body 150 having an upper end 152, a length 154, and a lower end 156 opposite the upper end 152. A first passageway 158 extends entirely through the length of the stanchion body 150 from the upper end 152 to the lower end 156. The stanchion 104 also includes at least one stanchion duct 160 extending from the first passageway 158 outward relative to the length of the stanchion body 150, exiting the stanchion body 150 at a stanchion duct aperture 116. In practice, there can be a plurality of stanchion ducts 160 and corresponding stanchion duct apertures 116. For example, three to six stanchion duct apertures 116 may be utilized. As such, three to six corresponding stanchion ducts 160 are utilized.

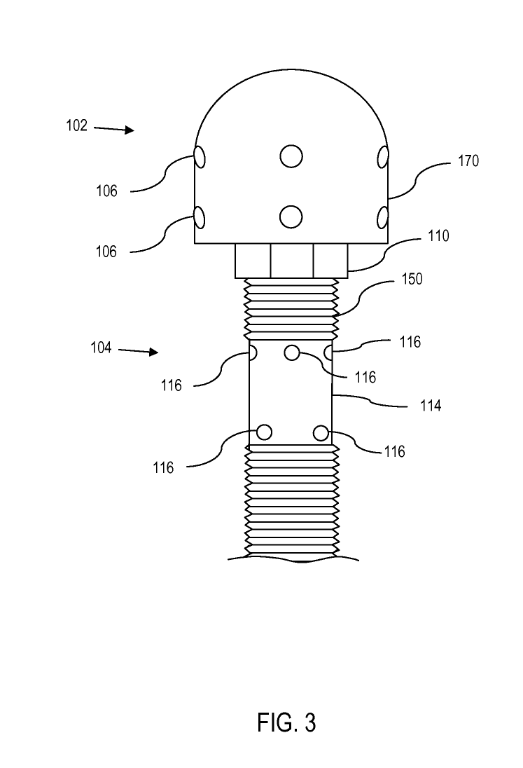

In an illustrative implementation as illustrated, the plurality of stanchion ducts 160 are arranged in a single row. In alternative configurations, the plurality of stanchion ducts 160 are arranged in at least two rows (see the example of FIG. 3). In the example of FIG. 3, each stanchion duct 160 exits the stanchion body at a corresponding stanchion duct aperture 116 defining at least two rings of stanchion duct apertures 116 about the circumference of the stanchion body 150. In yet alternative examples, the stanchion ducts 160 can be randomly scattered about the discharge area 114. Still further, one stanchion duct 160 may feed multiple stanchion duct apertures 116.

The stanchion duct(s) 160 may pass through the stanchion body 150 outward in a radial direction (e.g., from a top view perspective) relative to the stanchion body 150. Alternatively, the stanchion duct(s) 160 may pass through the stanchion body 150 outward in a non-radial direction from a top view perspective. Moreover, the stanchion duct(s) 160 can extend in a downward angled direction toward the lower end 156 of the stanchion body 150 relative to the length 154 of the stanchion body 150. Still further, the stanchion duct(s) 160 can pass from the first passageway 158 to the corresponding stanchion duct aperture 116 in any desired path, horizontal, bending downward, etc. Moreover, the stanchion duct apertures 116 may be evenly spaced around a circumference of the stanchion body 150. Alternatively, the stanchion duct apertures 116 need not be evenly spaced around the circumference of the stanchion body 150. Moreover, the stanchion duct apertures 116 need not be aligned along the length 154 of the stanchion body 150. Rather, the stanchion duct apertures 116 can be staggered in the length dimension.

The head 102 is fixedly positioned to the stanchion body 150 so as to be positioned spaced from, and not covering the stanchion duct aperture(s) 116. For instance, as illustrated, the head 102 includes a head housing (head body) 170 having a cap 172, a length 174, and a base opposite the cap 172. A second passageway 178 extends from the base 176 into the head body 170 forming a through connection with the first passageway 158. For instance, an overall passageway flows entirely through from the bottom of the stanchion 104 into the body of the head 102 via the first passageway 158 and the second passageway 178. The head 102 also includes at least one head duct 180 extending from the second passageway 178 outward relative to the length of the head body 170, and in an angled direction toward the base 176 of the head body 170 relative to the length 174 of the head body 170, exiting the head body 170 at a head duct aperture 106.

For instance, the head duct 180 can further extend from the second passageway 178 outward in a radial direction relative to a top view of the head body 170. Moreover, there may be a plurality of head ducts 180 extending from the second passageway outward relative to the head, each head duct 180 exiting the head body 170 at a head duct aperture 106.

In certain implementations, the plurality of head ducts 180 extending from the second passageway outward relative to the head body 170 can be arranged in a row (FIG. 2). Still further, in certain implementations, the plurality of head ducts 180 extending from the second passageway outward relative to the head body 170 can be arranged in at least two rows, each head duct 180 exiting the head body at a head duct aperture 106 defining at least two rings of head duct apertures 182 about the circumference of the head 102 (FIG. 3).

The head duct(s) 180 may pass through the head body 170 outward in a radial direction (e.g., from a top view perspective) relative to the length of the head body 170. Alternatively, the head duct(s) 180 may pass through the head body 170 outward in a non-radial direction from a top view perspective. Moreover, the head duct(s) 180 can extend in a downward angled direction (relative to the length of the stanchion 104). Still further, the head duct(s) 180 can pass from the second passageway 178 to the corresponding head duct aperture 106 in any desired path, horizontal, bending downward, etc. Moreover, the head duct aperture(s) 106 may be evenly spaced around a circumference of the head body 170. Alternatively, the head duct aperture(s) 106 need not be evenly spaced around the circumference of the head body 170. Moreover, the head duct aperture(s) 106 need not be aligned along the length head body 170. Rather, the head duct aperture(s) 106 can be staggered in the length dimension.

In practice, there can be a plurality of head ducts 180 and corresponding head duct apertures 106. For example, three to six head duct apertures 106 may be utilized. Correspondingly, three to six head ducts 180 can be utilized. Also, one head duct 180 may feed multiple head duct apertures 106.

Referring to FIG. 3, a zoomed-in view of the head 102 and an upper section of the stanchion 104 illustrate an alternative example arrangement of the head duct apertures 106 and stanchion duct apertures 116 compared to that set out in FIG. 1. There are multiple rows of head duct apertures 106. This can be utilized to facilitate cleaning of different regions of the birdbath basin, and may be used to expel water from the basin. In practice, any number of rows can be provided. Alternatively, the head duct apertures 106 can be scattered across the head body 170. Also, there can be a different number of head duct apertures 106 in each row, although the number of head duct apertures 106 can be the same. Moreover, the head duct apertures 106 need not be vertically aligned, although they can be.

Moreover, there are multiple rows of stanchion duct apertures 116. This can be utilized to facilitate three phases of cleaning. Even more phases can be incorporated by adding additional rows of stanchion duct apertures 116. Also, there are a different number of stanchion duct apertures 116 in the upper row compared to the lower row to illustrate that the number of stanchion duct apertures 116 need not be the same, although it can be. Moreover, the stanchion duct apertures 116 are not vertically aligned, again to demonstrate that the stanchion duct apertures 116 can vertically align or be offset, depending upon the desired cleaning effect. Yet further, although there are two rows of head duct apertures 106 and two rows of stanchion duct apertures 116 as illustrated, there can be different numbers of rows of apertures in the head 102 relative to the stanchion 104.

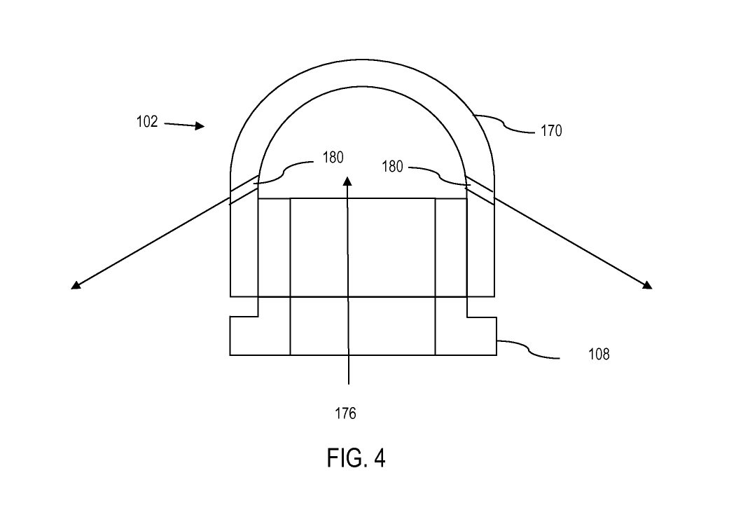

Referring to FIG. 4, when water is injected through the second passageway 178 (e.g., via the first passageway 158 (not shown for clarity of discussion), water fills the inside of the head body 170 and is ejected through the head ducts 180 and exits the head 102 at a downward angle as illustrated by the directional arrows.

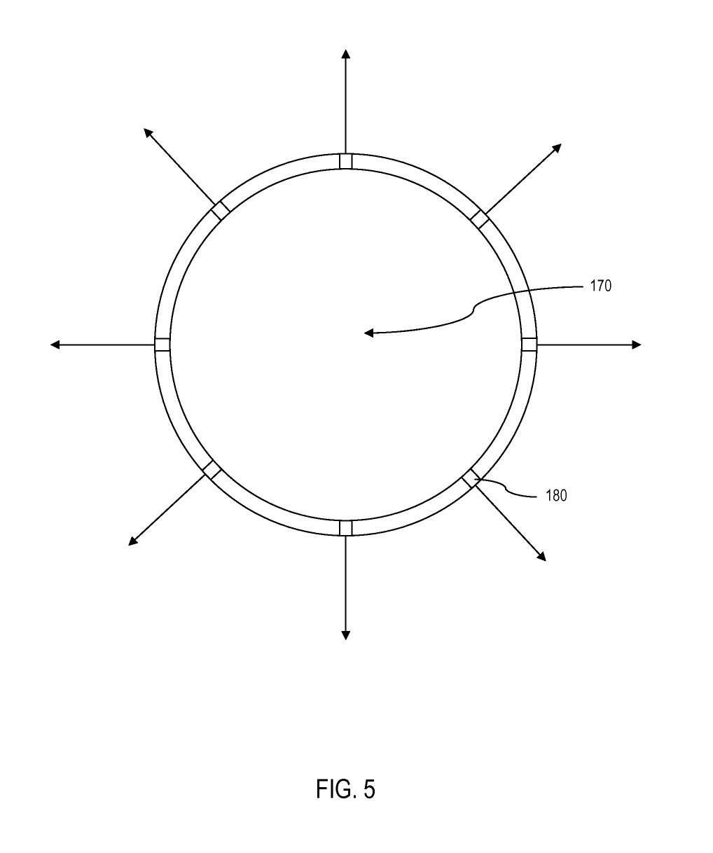

Referring to FIG. 5, a view is illustrated looking down at the top of the head 102. Notably, from a top view perspective, it appears as if the water is ejected in a generally radial direction. However, such need not be the case. The water may be ejected at a tangential angle. Moreover, some head ducts 180 may direct the water in a radial direction (from a top view perspective) whereas some head ducts 180 may eject water in a tangential direction (from a top view perspective). However, from a side view, the water is ejected at a downward angle. The specific angle can vary, but the angle should be sufficient to be able to agitate and remove water from a birdbath basin as described more fully herein.

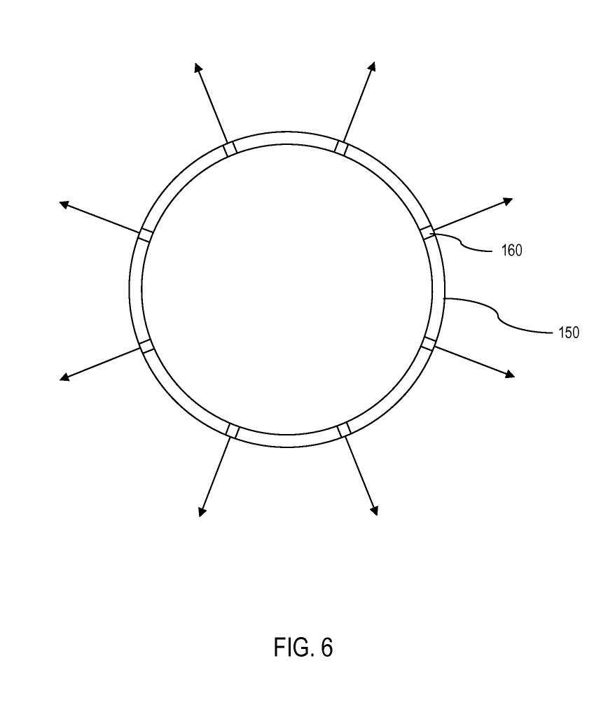

Referring to FIG. 6, a view is illustrated looking down at the top of the stanchion 104. Notably, from a top view perspective, it appears as if the water is ejected from the stanchion 104 in a generally radial direction. However, such need not be the case. The water may be ejected at a tangential angle. Moreover, some stanchion ducts 160 may direct the water in a radial direction (from a top view perspective) whereas some stanchion ducts 160 may eject water in a tangential direction (from a top view perspective). Moreover, from a side view, the water may be ejected out in a radial direction, at a downward angle, at an upward angle, or at some combination of the above. The specific angle(s) can vary, but the angle should be sufficient to be able to clean a birdbath basin as described more fully herein.

Comparing FIG. 5 to FIG. 6, it can be seen that the head duct apertures 182 are offset from the stanchion duct apertures 116. This allows water to be ejected in a greater number of directions. However, the head

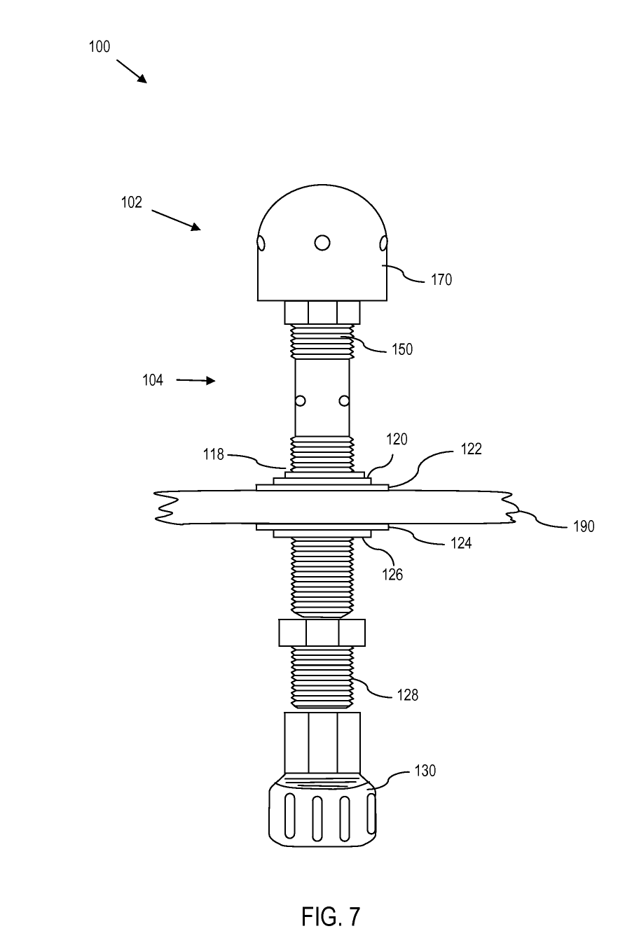

Referring to FIG. 7, the water exchange device 100 is illustrated connected to a basin of a birdbath 190. Basically, a hole is drilled into the basin of the birdbath 190. The stanchion 104 is passed through the hole in the birdbath 190, and is secured in place at a desired height by tightening the top jam nut 118 (and corresponding washer 120 and neoprene washer 122) on top of the basin, and tightening the second jam nut 126 (and corresponding washer 124) against the bottom of the basin of the birdbath.

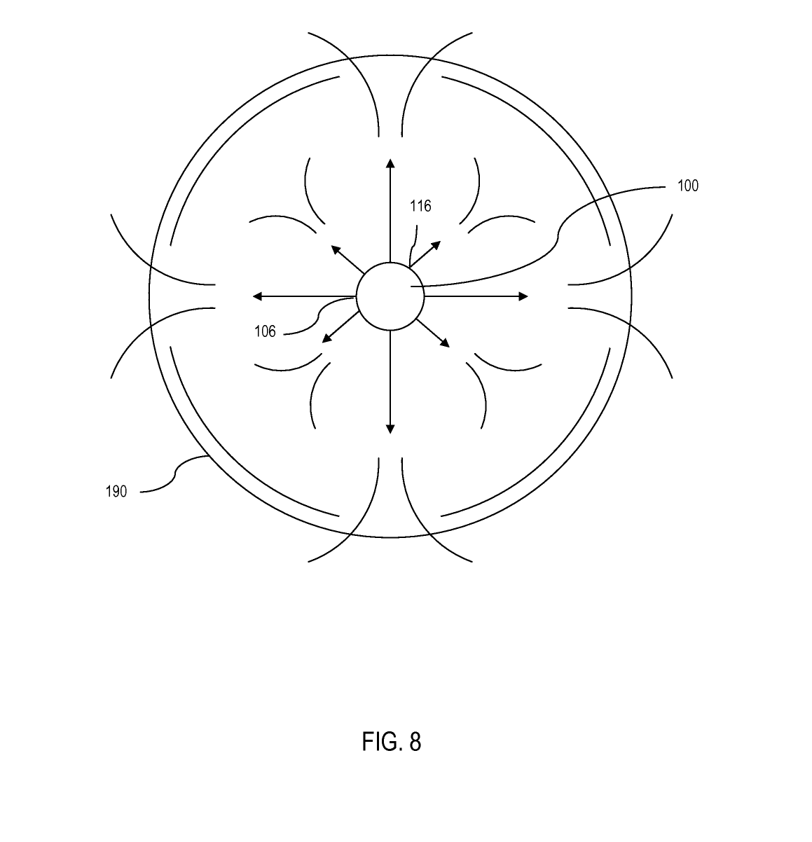

Referring to FIG. 8, looking at a top view, it can be seen that the head duct apertures 106 are offset from the stanchion duct apertures 116. As such, each aperture discharges water into a separate part of the basin of a birdbath 190.

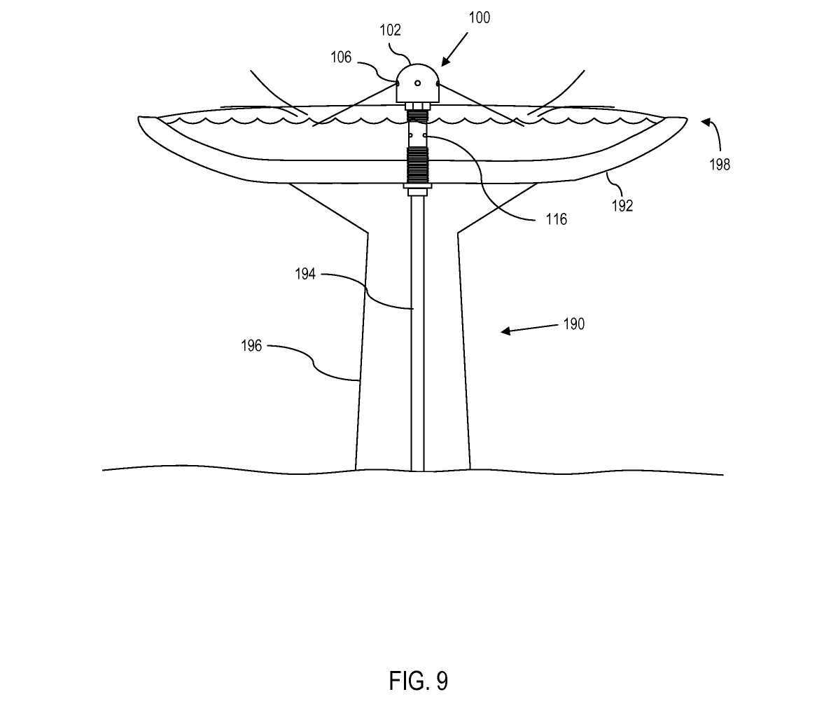

Referring to FIG. 9, in normal use, the water exchange device 100 attaches to a basin 192 of a birdbath 190, and connects to a water supply line 194, which typically travels up and inside a pedestal 196 of the birdbath 190. The water exchange device 100 is positioned such that the head 102 is above the typical water line 198, but the stanchion duct apertures 116 are below the water line 198. As the first phase of the cleaning cycle commences, water is ejected from the stanchion duct apertures 116 as well as the head duct apertures 106. However, the exit of water from the stanchion duct apertures 116 is resisted by the pressure of water within the basin 192 of the birdbath 190. However, since the head duct apertures 106 are open to air, the water exiting these apertures is relatively more forceful. As the water is ejected at a downward angle towards/proximate the inside edge of the basin 192, the water within the basin is agitated, and expelled from the basin 192. As the water is expelled, the overall water line 198 begins to drop until eventually, the stanchion duct apertures 116 are exposed above the water level.

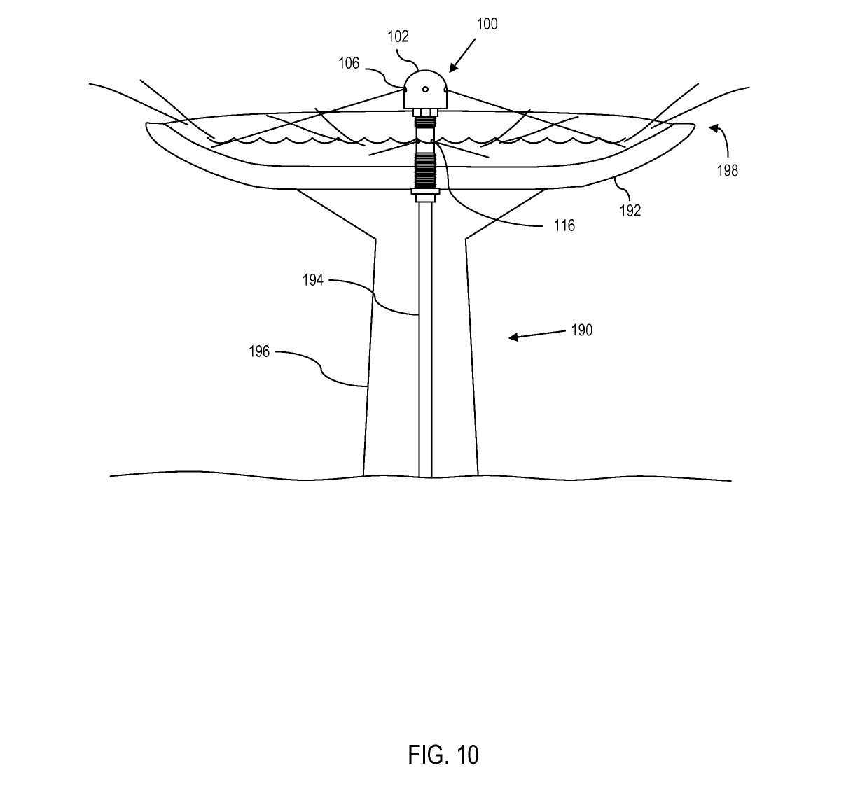

Referring to FIG. 10, the stanchion duct apertures 116 are now still submerged, but very close to the surface of the water in the basin 192. As such, the pressure of water exiting the stanchion duct apertures 116 begins to increase. Moreover, the water pressure exits the stanchion duct apertures 116 at an angle/direction more parallel to the bottom of the basin 192 of the birdbath 190 relative to the angle of the water exiting the head duct apertures 106. As such, the water exiting the stanchion duct apertures 116 serves to remove any remaining stale water, and any remaining debris from the lower level of the basin 192. Once the remaining stale water has been removed, or substantially diluted, the water pressure is reduced, e.g., to a trickle, to allow the basin to refill with fresh water. (The water exchange device may not scrub clean the basin, but will at least remove stale water and debris, preventing the basin from getting stained. The water exchange device also refills with fresh water.)

As such, the water exchange device 100 implements a non-rotating, multi-stage cleaning system that preferentially apportions the effective cleaning force to those apertures able to jettison water into the air, as opposed to any still-submerged apertures. The mass of the impounded water prevents any still submerged lower apertures from having any direct impact on the ultimate task of removing stale water from the basin. The impounded water, however, serves as a needed and effective temporary valve, restricting the pace of the water exiting below the water surface so that the majority of the available energy in the rising column of water within the head and stanchion is reserved for the upper apertures. Water which is initially dispersed into the air, and ultimately strikes the water surface, has direct impact on the task of removing stale water and debris from the basin. As the lower apertures are uncovered, they finish the task of emptying the basin by directing their water streams at the receding water surface, which receding surface the upper apertures are unable to reach at an appropriately shallow angle. Notably, water which strikes the surface at too steep of an angle, potentially runs into the mass of the impoundment so that the kinetic energy is easily dissipated with nothing gained. The multi-stage cleaning system enables the device to be effectively applied to locations even where the available water pressure is at the low end of the 40-70 psi spectrum.

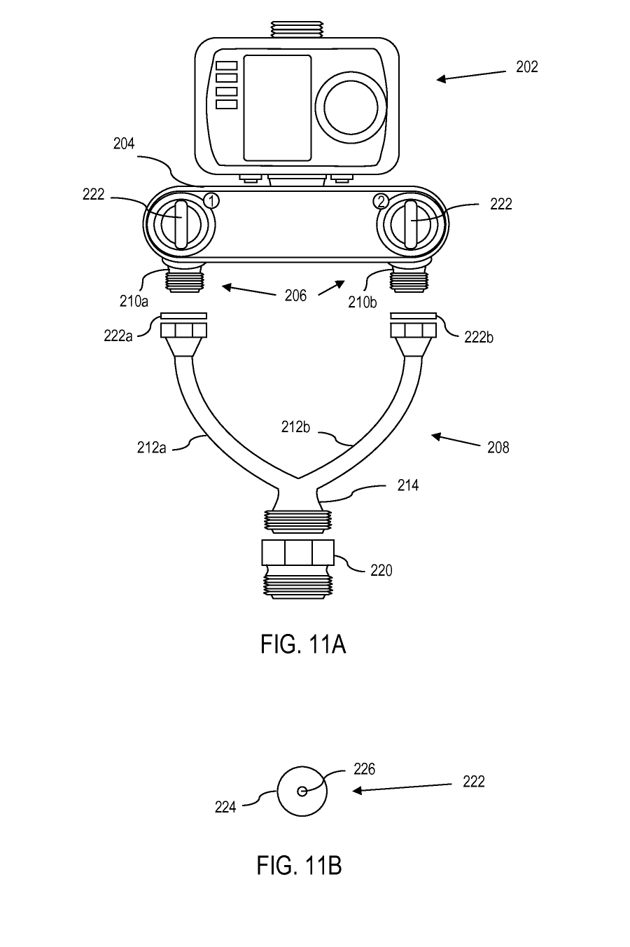

Turning now to FIG. 11A, the water exchange device 100 can be further utilized with a timer 202, such as a dual outlet battery powered garden hose timer 202. The timer 202 includes a flow controller 204 having a splitter 206. A combiner 208 couples to each output of the splitter 206. The flow controller 204 controls the flow of water from a water source into one channel 210a-b of the splitter 206 or to block the water from reaching any channel 210a-b of the splitter 206. As shown, the timer 202 is integrated into the splitter 206 of the flow controller 204; however, the timer 202 may be a separate component that couples to the flow controller 204. Further, as shown, the timer 202 controls the water to the splitter channels 210a-b; however, the timer 202 may instead control the flow allowed to pass from channels 210a-b. The timer 202 is configured to control the flow controller 204 to perform the exchange cycle (described more fully herein).

The splitter 206 includes at least two channels, however, the splitter 206 may include any number of channels 210. The illustrated splitter 206 includes two channels 210a-b. The timer 202 controls when water is passed to an individual channel 210a-b. Thus, the splitter 206 can split the flow of water from a central point to one or more channels, such as channels 210a-b, depending on the control from the timer 202.

The combiner 208 includes at least two channels, e.g., channels 212a-b as illustrated, and combines the flow from the channels 210a-b (even if flow is present in only one channel 210) to a common channel 214. Typically the combiner 208 will include the same number of channels as the splitter 206. Also as illustrated, a vacuum breaker 220 is provided at the output of the common channel 214. In an example implementation, a dual-valve splitter 206 splitter preserves the use of the timer's manual option so that the user may divert water for non-timed general watering needs. Moreover, in certain implementations, each leg of the splitter 206 may require its own vacuum breaker 220.

The first splitter channel 210a is coupled to the first combiner channel 212a, and the second splitter channel 210b is coupled to the second combiner channel 212b. As shown, the splitter 206 and combiner 208 are two separate pieces; however, the splitter 206 and combiner 208 may be one integral piece.

Moreover, one or more of the splitter channels 210a-b, one or more of the combiner channels 212a-b, or both may have a flow reducer 220a-220b (e.g., valve, rubber washer, metal washer, O-ring, etc.) that reduce the flow of water from the water source based on a signal from the timer 202. For example, the first splitter channel 210a may include a flow reducer 220a that reduces the flow, which in turn reduces the water pressure as the water is discharged during an emptying cycle. Further, the second splitter channel 210b may have a flow reducer 220b that reduces the flow further such that the water pressure during a refill cycle is less than the pressure during the emptying cycle. As such, when the timer 202 determines that it is time for an exchange cycle, the timer 202 can allow water to flow through the first splitter channel 210a during the emptying cycle. After the emptying cycle is complete, the timer 202 can allow water to flow through the second splitter channel 210b during the refill cycle.

Referring briefly to FIG. 11B, where the flow reducer 222 is implemented as a metal washer, the flow reducer includes a body 224 and an aperture 226 within the center of the body. The size of the aperture restricts flow to a desired flow rate. In an example implementation, the aperture is 1/16 inch (0.16 centimeter) to ⅛ inch (0.3175 centimeter) center hole.

For example, the timer 202 may be an off-the-shelf timer such as a Nelson two-outlet, battery operated timer, which allows six hour intervals. This allows cleaning cycles to keep up with even the busiest of garden aviary. This example timer 202 allows the capacity to schedule three combined discharge and refill operations during daylight hours, peak times for aviary activity. As such, algae and other basin-staining agents are deprived of the uninterrupted time necessary to secure an attachment to the basin surface. This also eliminates an otherwise suitable habitat for pests such as mosquitoes. Yet further, because birds frequent areas where clean water is provided, the device 100 should improve aviary activity about the birdbath.

An exchange cycle includes at least two operations: an emptying cycle and a refill cycle. There can be up to six exchange cycles per day using the Nelson timer. Thus, if the water exchange device 100 is to be operated over a twelve-hour daylight period (the typical time birds are active), then the water exchange device 100 can perform six exchange cycles spaced about two to three hours apart. With such a small interval of time between cycles, the water does not get a chance to become overly contaminated and refuse and algae does not have time to adhere to the basin of the birdbath.

Further, a kit may include a siphon (not shown) that is configured to allow water left in the water exchange device 100 after the refill cycle to drain from the water exchange device 100 so the device will not freeze if the temperature reaches below freezing. The timer 202 and flow controller 204 may be coupled to the birdbath and water source by any appropriate conduit (e.g., hose, pipe, etc.).

While the water exchange device 100 described above is discussed as retrofitting an existing birdbath with a basin and a hollow pedestal, the water exchange device 100, in any embodiment can be integrated directly into a birdbath.

Due to a vigorous infusion of fresh water released from the a first outlet of the timer, e.g., every 2-6 hours, all of the stale water is removed by the end of a discharge cycle (typically 1 minute long). The contaminated water and any particulates are propelled outwardly away from the basin and then atomized into a spray of water reaching out within a radius as much as 10 feet (3.05 meters) from the basin rim. The atomization feature avoids flooding conditions at the base of the birdbath, and provides a simultaneous irrigation of plants surrounding the birdbath. That irrigation can be extended beyond the one minute standard discharge cycle, e.g., for 10 minutes, in order to provide a once-a-day, more thorough irrigation for those plants surrounding the birdbath.

As noted in greater detail herein, both the head and the threaded stanchion have at least one row of apertures around their circumferences. After the discharge from the top row of apertures in the head has substantially lowered the level of the water in the basin, a second stage of the discharge cycle follows with a surge of fresh water from the apertures in the now-exposed portion of the stanchion. Following each discharge cycle, fresh water is then slowly added at a much lower water pressure from a second outlet of the timer, so that by the end of the refill cycle (typically 1 minute long), the water level in the basin is restored to full capacity.

The system requires no pump, but instead relies on standard household water pressure, typically available at the exterior hose bib. If the length of a ⅝″ buried hose is to extend beyond 50 feet, a garden hose with an inside diameter of ¾″ should be selected.

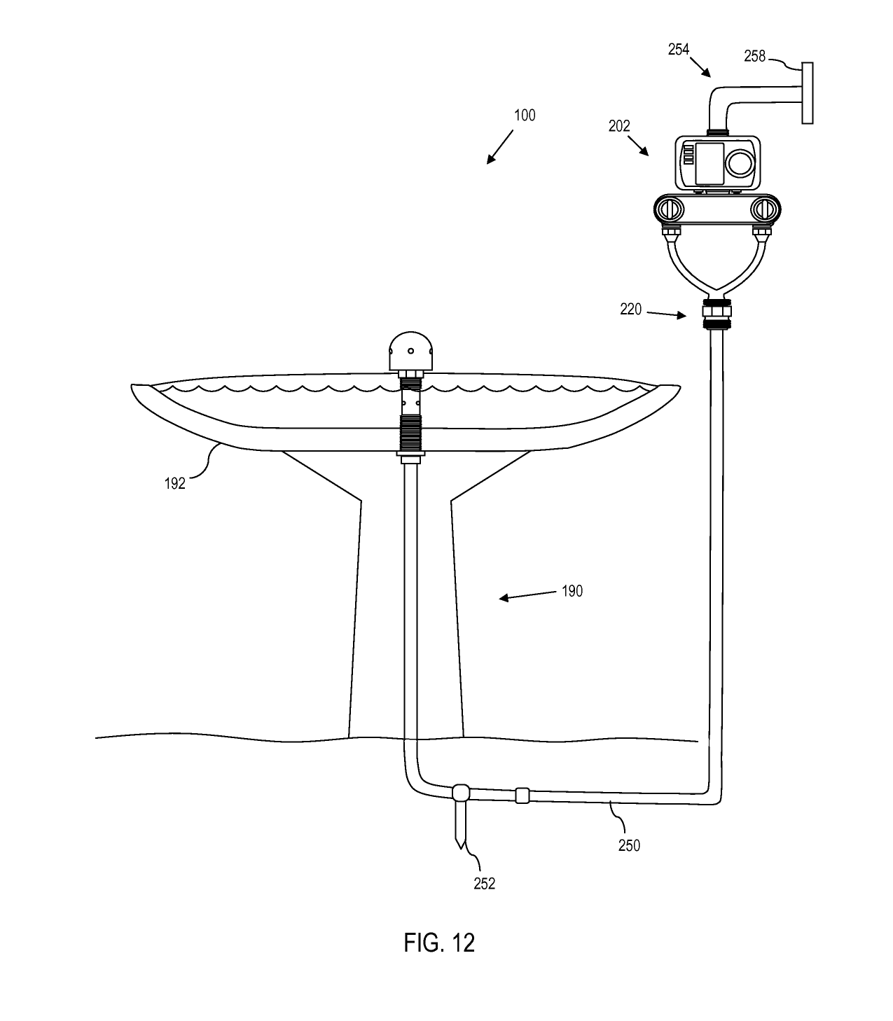

Referring to FIG. 12, a supply line 250 to the water exchange device 100 can be buried under ground. The burial of the supply line 250 maintains desired aesthetics by keeping the supply line 250 (e.g., garden hose, rigid irrigation pipe such as PVC pipe, etc.) out of sight. Moreover, burying the supply line 250 prevents the water in the supply line 250 from being super-heated as may occur if the supply line 250 were otherwise laying for hours out in the hot sun. Yet further, the supply line 250 provides part of the anchor system.

In an example implementation, the supply line 250 includes a reinforced spiral connecting hose that cooperates with a pipe bracket 252, such as a galvanized u-shaped pipe bracket, with 2 mounting holes for use with two long galvanized spikes to define an anchoring system. Thus, the spiral hose can serve as a linkage between an anchoring system of the buried garden hose and the birdbath basin. By helping to firmly secure the basin to the pedestal, the spiral hose reduces the risk of damage to the birdbath, otherwise arising from a basin tip-over. Especially in the instance of hollow pedestals, the spiral hose also provides a needed assist to the forces of gravity in holding the entire birdbath in place and upright.

Garden hose water timers 202 have been known to sometimes cause a “water hammer” noise, in the water supply lines in the house. The sudden closure of a timer valve which had been passing water at full velocity sends a shockwave of energy back into water supply line coming from the house. A beginning loop 254 of garden hose may be set up before attaching the timer. Such may be desirable when installing the water exchange device 100 in relatively flat terrain. The loop 254 allows an atmospheric vacuum breaker 220 to be correctly placed at an elevation which is at least 6 inches (15.24 centimeters) higher than the elevation of the birdbath basin rim. The beginning loop 254 of flexible garden hose absorbs the shock wave, and prevents the hammer noise from happening. The beginning hose loop also carries an incidental benefit of enabling the timer controls and display screen to be brought up to eye level.

In an example configuration, the water exchange device can work with water pressure from a hose bib 258 as low as 50 pounds per square inch (PSI). However, the specific application will dictate the necessary pressure.

In situations where the pressure regulator cannot be adjusted to suitably increase the water pressure, and the second stage of the cleaning cycle is unable to fully engage so as to spray the ejected water into the air, the stale water will still be effectively removed by the end of the discharge cycle. In this instance, decorative rocks or other erosion control measures surrounding the base of the birdbath pedestal would be appropriate in this circumstance. Moreover, for birdbath installations close to a window where there is no desire to spray the discharge water into the air, it may be necessary to reduce the effective water pressure by partially closing the supply valve.

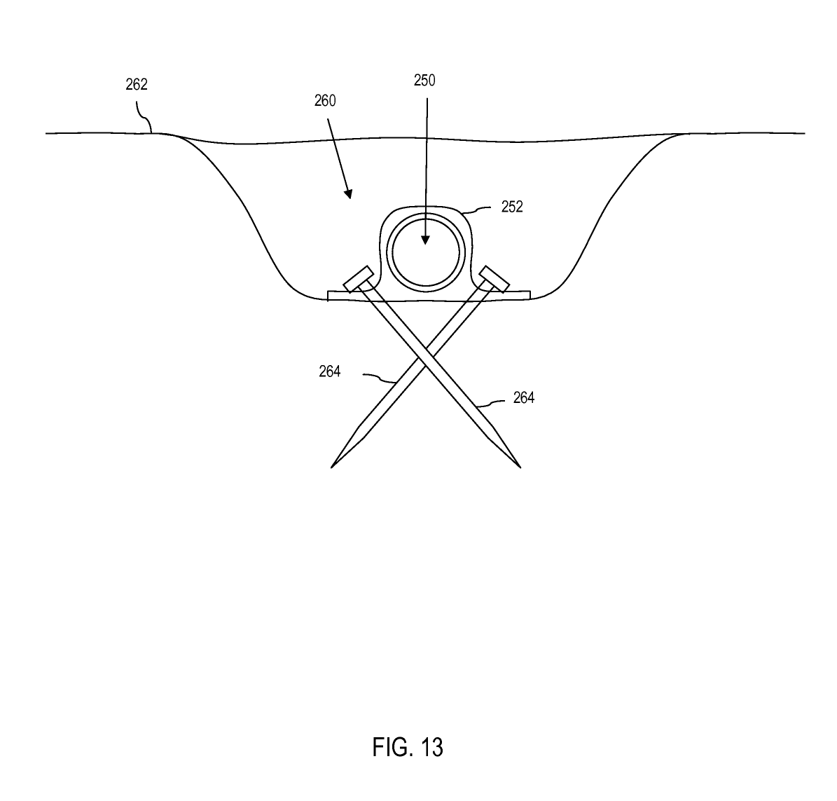

Referring to FIG. 13, a trench 260 is dug below the surface of the ground 262. For instance, the supply line should typically be buried at least 6 inches (15.24 centimeters), but preferably 12 inches (30.48 centimeters) below the ground from the timer assembly to the selected site. The supply line 250 is run from the timer 202 (not shown) to a position underneath the basin of the birdbath. Moreover, the pipe bracket 252 can utilize long angled spikes 264 to secure the supply line 250 underground.

With reference to the FIGURES generally, to install a water exchange device, it is desirable to extend the trench to the nearest edge of the desired location for the birdbath, so that nearly all of the pedestal base will be resting on undisturbed, and solid ground. The last 5 feet (1.52 meters) of the trench may be left unfilled with dirt until the final connection has been made with the reinforced spiral connecting hose, and the system has been tested. If mounting the water exchange device 100 into an existing birdbath, a user can drill a vertical ¾″ (1.9 centimeter) hole in the very center of the birdbath basin using a diamond-tipped hole saw, then attach the water exchange device 100 as set out in greater detail herein. For instance, the stanchion passes through a hole in the basin and is sealingly tightened against the basin, such as using the washers and jam nuts described with reference to FIG. 1. The user then attaches a spiral reinforced connecting hose to the exposed end of the nipple assembly of the water exchange device at the underneath side of the basin.

Also, a user inserts a free end of the reinforced spiral hose into and through the pedestal, and place the now-combined pedestal/basin assembly on the selected site. The user extends the free end of the spiral connecting hose toward the water supply line, and matches the end of the reinforced spiral connection hose lying in the bottom of the trench, to the point on the garden hose where the connection is to be made. The user then cuts off the excess portion of the garden hose supply line, and install a male garden hose coupling on the end of the garden hose. The user can then place the pipe bracket 252 over the spiral connecting hose at the edge of the pedestal, and drive the two ground-anchoring nails fully into the under-disturbed soil below.

If available, a site location for the birdbath affording a ground elevation which is approximately 3 feet (0.9144 meters) lower than the installed elevation of an atmospheric vacuum breaker is desirable. Otherwise, a suitably higher position for the atmospheric vacuum breaker may be identified, ensuring that the atmospheric vacuum breaker will rest at least 6 inches (15.24 centimeters) higher than the rim elevation of the birdbath basin. A loop of hose can be installed in order to elevate the position of the vacuum breaker 220 above the elevation of the birdbath rim.

Even in applications where the terrain falls significantly away from a house, it may be advisable to also first attach a 5 to 6 foot (1.52-1.83 meters) section of garden hose running from the hose bib 258 to the timer 202 in order to prevent “water hammer” noise. The sudden closure of a timer valve, which had been passing water at a high velocity, can send a shockwave of energy back into the water supply line coming from the house. A 5 to 6 foot (1.52-1.83 meters) long section of flexible garden hose efficiently absorbs the shock wave before it can enter the house, and prevents any hammer noise from occurring.

The water exchange device 100 may require the delivery of a strong water pressure to the birdbath in order to carry out the two-stage (or multi-stage) cleaning cycle. Here, the water pressure at the basin will be significantly influenced by the GPM (gallons per minute) delivered by the water supply line. Many if not all anti-siphon valves somewhat reduce the downstream GPM. It is therefore usually necessary to remove any existing anti-siphon valve from the hose bib, and in any event install an atmospheric vacuum breaker 220, which does not reduce the GPM, but still protects the domestic water supply from any backflow. Because a atmospheric vacuum breaker 220 is not designed to withstand exposure to constant water pressure, it must be attached at some point downstream of the timer assembly 202, and not attached to the hose bib 258.

In a situation where a garden hose loop 254 will be employed to elevate the atmospheric vacuum breaker 220, or is employed for the purpose of forestalling any hammer noises in the household water pipes, the suggested sequence of attachments is to attach the section of garden hose 254 to the hose bib (spigot) 258. Then, attach the timer 202 to the elevated end of the hose loop 254 and attach the hose couplings of a combiner hose assembly to the two outlets of the timer. Next, attach an atmospheric vacuum breaker 220 to the bottom of the “Y” hose combiner and then attach the atmospheric vacuum breaker 220 to the supply line that runs to the birdbath and ultimately to the water exchange device. A supply line split may also be provided, e.g., to run one hose to the birdbath and attach a garden hose that runs to an adjacent hose reel. The split may be provided on the timer itself.

In an illustrative example, a first side (first outlet) of the timer valve will provide an unrestricted full-force flow to the birdbath for a one minute cleaning cycle (or longer cycle where it is desirable to water nearby plants). A second valve (second outlet) will provide a much restricted flow for a slow-paced, one minute refill cycle. For instance, a flow restricting device is installed in the female coupling of the “Y” hose assembly. The restricted flow side of the “Y” hose assembly is attached to the timer's second outlet, and the unrestricted side of the “Y” hose assembly is attached to the timer's first outlet.

The second outlet of the timer will also remain available for general yard watering needs, e.g., by engaging a manual button on the face of the timer control to direct water an attached garden reel.

According to aspects of the present disclosure herein, a method of cleaning a birdbath comprises connecting a water exchange device to a basin of a birdbath. The water exchange device is as set out in greater detail herein with regard to FIGS. 1-13. For instance, the water exchange device comprises a stanchion having a stanchion body having an upper end, a length, and a lower end opposite the upper end. A first passageway passes entirely through the length of the stanchion body from the upper end to the lower end. Also, a plurality of stanchion ducts extend from the first passageway outward relative to the length of the stanchion body, each of the plurality of stanchion ducts exiting the stanchion body at a stanchion duct aperture. The water exchange device also comprises a head fixedly positioned to the stanchion body so as to be positioned spaced from, and not covering the stanchion duct aperture. The head includes a head housing having a cap, a length, and a base opposite the cap. A second passageway extends from the base into the head body forming a through connection with the first passageway. Moreover, a plurality of head ducts extending from the second passageway outward relative to the length of the head body, and in an angled direction toward the base of the head body relative to the length of the head body, each of the plurality of head ducts exiting the head body at a head duct aperture.

The method also comprises adjusting the position of the stanchion such that the stanchion duct is below a surface of water in the birdbath basin, and the head duct aperture is above the surface of water in the birdbath basin. The method still further comprises ejecting water through the water exchange device at a first pressure such that water exiting the head duct aperture expels water from the basin of the birdbath sufficient to lower the water in the basin until the stanchion duct is no longer under water, ejecting water through the water exchange device at a pressure such that water exits the head duct aperture and the stanchion duct aperture with sufficient force to clean the basin of the birdbath, and ejecting water through the water exchange device at a second pressure so as to refill the basin of the birdbath with fresh water.

As such, the water exchange device can be used to implement two stages of cleaning with a single water pressure from a water source by providing the plurality of stanchion duct apertures as a row of stanchion duct apertures below the surface of water in the basin when the birdbath basin is filled, and providing the plurality of head duct apertures as a row of head duct apertures above the surface of the water in the basin when the birdbath is filled. The water in the basin resists water from being ejected from the stanchion duct apertures so long as the stanchion duct apertures are under water, thus increasing the pressure of the water exiting the head apertures. Moreover, the pressure of the water exiting the water exchange device evens out between the head duct apertures and the stanchion duct apertures when the water level in the basin drops below the stanchion duct apertures.

The method may also comprise implementing three stages of cleaning with a single water pressure from a water source by providing the plurality of stanchion duct apertures as a first row of stanchion duct apertures below the surface of water in the basin when the birdbath basin is filled and a second row of stanchion duct apertures below the surface of water in the basin when the birdbath basin is filled, the second row being below the first row. The method also comprises providing the plurality of head duct apertures as row of head duct apertures above the surface of the water in the basin when the birdbath is filled. Here, the water in the basin resists water from being ejected from the stanchion duct apertures so long as the stanchion duct apertures are under water, thus increasing the pressure of the water exiting the head apertures. Also, the pressure of the water exiting head duct apertures is at a first pressure when both the first row of stanchion duct apertures and the second row of stanchion duct apertures is below the surface of water in the basin. Moreover, the pressure of the water exiting the head duct apertures is at a second pressure different from the first pressure when the first row of stanchion duct apertures is above the water level of water in the basin, and the second row of stanchion duct apertures is below the surface of water in the basin. Yet further, the pressure of water exiting the head duct apertures is at a third pressure different from the second pressure when both the first row of stanchion duct apertures and the second row of stanchion duct apertures is below the surface of water in the basin.

### Miscellaneous

According to aspects of the present disclosure, a water exchange device 100 provides a recurring discharge cycle, which releases a vigorous infusion of fresh water, e.g., every 2-6 hours or other suitable time, from a first outlet of the timer, dislodging all of the stale water and debris. The water exchange device 100 also provides an irrigation effect. During the discharge cycle, the water exchange device 100 atomizes the ejected discharge water into a fine spray, reaching out to the circle of plantings surrounding the basin rim of the birdbath.

Still further, a single pressure can provide two or more distinct stages of cleaning because the water pressure in the basin may resist water existing stanchion duct apertures as described more fully herein. There is also a second pressure to refill the basin. As such, two pressure levels can provide three or more distinct cleaning cycles.

During a refill operation, the water exchange device slowly restores the birdbath basin to full capacity from a second timer outlet. Moreover, in typical applications where the supply line is buried, cool water is supplied. Because the supply line is buried, none of the fresh water brought to the basin has been superheated by a garden hose otherwise sitting for hours in the hot sun. The buried supply line serves second purpose of securely fastening the basin and pedestal to the ground, thus providing improved stability. Also, by concealing the presence of the water supply line, the water exchange device preserves the positive appearance an attractive garden scene, complimented by a functional birdbath. The water exchange device 100 requires no pump, but instead relies on standard household water pressure, typically available at the exterior hose bib.

The water exchange device can be adapted to all hollow pedestal birdbaths having an open-core diameter of at least 1½ inches (3.81 centimeters).

According to further aspects of the present disclosure, a kit includes a battery-operated garden hose timer with at least two programmable outlets, the water exchange device 100 having a continuously threaded riser/body portion of the stanchion, and mechanical fittings for securing the water exchange device to the basin. A “Y” hose assembly is provided for channeling the discharge from each of the two timer outlets into a single supply line, and a dual control “Y” splitter, enabling the use of the timer's manual control option for general watering needs. A backflow prevention valve can be used to protect the integrity of the domestic water supply within the home. Also, a short length, e.g., a three-foot (91.44 centimeter) length of reinforced spiral hose can be used for connecting the water exchange device to a buried supply line. Yet further, a ground-anchoring staple-assembly can be attached to the spiral hose, firmly securing the basin to the pedestal, and the entire birdbath structure to the ground.

Optional items can include a diamond-tipped, masonry hole-cutting saw, to be used for task of establishing a center hole in the basin. A garden hose thread-conversion adapter can also be provided, e.g., for an arrowhead bib. Moreover, a vinyl basin-cover can be provided, e.g., to provide protection of the water exchange device for the winter.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A water exchange device for a birdbath, comprising:
a stanchion having:
a stanchion body having an upper end, a length, and a lower end opposite the upper end;
a first passageway entirely through the length of the stanchion body from the upper end to the lower end; and
a stanchion duct extending from the first passageway outward relative to the length of the stanchion body, exiting the stanchion body at a stanchion duct aperture; and
a head fixedly positioned to the stanchion body so as to be positioned spaced from, and not covering the stanchion duct aperture, the head having:
a head body having a cap, a length, and a base opposite the cap;
a second passageway extending from the base into the head body forming a through connection with the first passageway; and
a head duct extending from the second passageway outward relative to the length of the head body, and in an angled direction toward the base of the head body relative to the length of the head body, exiting the head body at a head duct aperture.

2. The water exchange device of claim 1, wherein:
the stanchion duct further extends from the first passageway outward in a radial direction relative to a top view of the stanchion body.

3. The water exchange device of claim 1, wherein:
the stanchion duct extends in a downward angled direction toward the lower end of the stanchion body relative to the length of the stanchion body.

4. The water exchange device of claim 1 further comprising:
a plurality of stanchion ducts extending from the first passageway outward relative to the length of the stanchion body, each stanchion duct exiting the stanchion body at a stanchion duct aperture.

5. The water exchange device of claim 1 further comprising:
a plurality of stanchion ducts extending from the first passageway outward relative to the length of the stanchion body arranged in at least two rows, each stanchion duct exiting the stanchion body at a stanchion duct aperture defining at least two rings of stanchion duct apertures about the circumference of the stanchion.

6. The water exchange device of claim 1, wherein:
a head duct further extends from the second passageway outward in a radial direction relative to a top view of the head body.

7. The water exchange device of claim 1 further comprising:
a head duct extending from the second passageway outward relative to the length of the head body, and in an angled direction toward the base of the head body relative to the length of the head body, exiting the head body at a head duct aperture.

8. The water exchange device of claim 1 further comprising:
a plurality of head ducts extending from the second passageway outward relative to the head, each head duct exiting the head body at a head duct aperture.

9. The water exchange device of claim 1 further comprising:
a plurality of head ducts extending from the second passageway outward relative to the head body arranged in at least two rows, each head duct exiting the head body at a head duct aperture defining at least two rings of head duct apertures about the circumference of the head.

10. The water exchange device of claim 1, wherein:
the stanchion body includes male threads extending a substantial length of the body.

11. The water exchange device of claim 10, wherein:
the stanchion body is free of male threads around the circumference of the stanchion body where the stanchion duct aperture exits the stanchion body.

12. A method of cleaning a birdbath, comprising:
connecting a water exchange device to a basin of a birdbath, the water exchange device comprising:
a stanchion having:
a stanchion body having an upper end, a length, and a lower end opposite the upper end;
a first passageway entirely through the length of the stanchion body from the upper end to the lower end; and
a plurality of stanchion ducts extending from the first passageway outward relative to the length of the stanchion body, each of the plurality of stanchion ducts exiting the stanchion body at a stanchion duct aperture; and
a head fixedly positioned to the stanchion body so as to be positioned spaced from, and not covering the stanchion duct aperture, the head having:
a head housing having a cap, a length, and a base opposite the cap;
a second passageway extending from the base into the head body forming a through connection with the first passageway; and
a plurality of head ducts extending from the second passageway outward relative to the length of the head body, and in an angled direction toward the base of the head body relative to the length of the head body, each of the plurality of head ducts exiting the head body at a head duct aperture;
adjusting the position of the stanchion such that the stanchion duct is below a surface of water in the birdbath basin, and the head duct aperture is above the surface of water in the birdbath basin;
ejecting water through the water exchange device at a first pressure such that water exiting the head duct aperture expels water from the basin of the birdbath sufficient to lower the water in the basin until the stanchion duct is no longer under water;
ejecting water through the water exchange device at a pressure such that water exits the head duct aperture and the stanchion duct aperture with sufficient force to empty water from the basin of the birdbath; and
ejecting water through the water exchange device at a second pressure so as to refill the basin of the birdbath with fresh water.

13. The method of claim 12 further comprising:
implementing two stages of cleaning with a single water pressure from a water source by:
providing the plurality of stanchion duct apertures as a row of stanchion duct apertures below the surface of water in the basin when the birdbath basin is filled;
providing the plurality of head duct apertures as a row of head duct apertures above the surface of the water in the basin when the birdbath is filled;
wherein:
the water in the basin resists water from being ejected from the stanchion duct apertures so long as the stanchion duct apertures are under water, thus increasing the pressure of the water exiting the head apertures; and
the pressure of the water exiting the water exchange device evens out between the head duct apertures and the stanchion duct apertures when the water level in the basin drops below the stanchion duct apertures.

14. The method of claim 12 further comprising:
implementing three stages of cleaning with a single water pressure from a water source by:
providing the plurality of stanchion duct apertures as a first row of stanchion duct apertures below the surface of water in the basin when the birdbath basin is filled and a second row of stanchion duct apertures below the surface of water in the basin when the birdbath basin is filled, the second row being below the first row;
providing the plurality of head duct apertures as row of head duct apertures above the surface of the water in the basin when the birdbath is filled;
wherein:
the water in the basin resists water from being ejected from the stanchion duct apertures so long as the stanchion duct apertures are under water, thus increasing the pressure of the water exiting the head apertures; and
the pressure of the water exiting head duct apertures is at a first pressure when both the first row of stanchion duct apertures and the second row of stanchion duct apertures is below the surface of water in the basin;
the pressure of the water exiting the head duct apertures is at a second pressure different from the first pressure when the first row of stanchion duct apertures is above the water level of water in the basin, and the second row of stanchion duct apertures is below the surface of water in the basin; and
the pressure of water exiting the head duct apertures is at a third pressure different from the second pressure when both the first row of stanchion duct apertures and the second row of stanchion duct apertures is below the surface of water in the basin.

15. The method of claim 12 further comprising:
configuring the device so as to preferentially apportion the effective cleaning force to those apertures able to jettison water into the air, as opposed to any still-submerged apertures such that the mass of the impounded water prevents any still submerged lower apertures from having any direct impact on the ultimate task of removing stale water from the basin; and
using the impounded water as a temporary valve, restricting the pace of the water exiting below the water surface so that the majority of the available energy in a rising column of water within the stanchion is reserved for the upper apertures above the water level; and
configuring the duct directions so that only water which is initially dispersed into the air, and ultimately strikes the water surface, has any direct impact on the task of removing stale water and debris from the basin such that as the lower apertures are uncovered, they finish the task of emptying the basin by directing their water streams at the receding water surface, which receding surface the upper apertures are unable to reach at an appropriately shallow angle.

16. A self-cleaning birdbath comprising:
a birdbath having a pedestal and a basin that rests on the pedestal;
a water exchange device comprising:
a stanchion having:
a stanchion body having an upper end, a length, and a lower end opposite the upper end;
a first passageway entirely through the length of the stanchion body from the upper end to the lower end; and
a stanchion duct extending from the first passageway outward relative to the length of the stanchion body, exiting the stanchion body at a stanchion duct aperture; and
a head fixedly positioned to the stanchion body so as to be positioned spaced from, and not covering the stanchion duct aperture, the head having:
a head housing having a cap, a length, and a base opposite the cap;
a second passageway extending from the base into the head body forming a through connection with the first passageway; and
a head duct extending from the second passageway outward relative to the length of the head body, and in an angled direction toward the base of the head body relative to the length of the head body, exiting the head body at a head duct aperture;
wherein:
the stanchion passes through a hole in the basin and is sealingly tightened against the basin.

17. The self-cleaning birdbath of claim 15 further comprising:
a water supply line that passes through the pedestal and connects to the water exchange device; and
a pipe bracket that gets buried under ground to secure the water supply line.

18. The self-cleaning birdbath of claim 15 further comprising:
a splitter that splits a water source into at least two channels, each channel configured to a different water pressure; and
a corresponding combiner that combines each channel into a common connection that connects to the water supply line.

19. The self-cleaning birdbath of claim 18 further comprising:
a timer connected to the splitter, the timer controlling the time that water can flow through each channel.

20. The self-cleaning birdbath of claim 19 further comprising:
an atmospheric vacuum breaker downstream of the timer.
